(19) United States
(12) Patent Application Publication
(10) Pub. No.: US 2006/0155549 A1
(43) Pub. Date: Jul. 13, 2006

(54) Imaging device and image output device

(75) Inventor: Takao Miyazaki, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/326,339

(22) Filed: Jan. 6, 2006

(30) Foreign Application Priority Data
Jan. 12, 2005 (JP) 2005-005402

(51) Int. Cl. G10L 11/00

(52) U.S. Cl. 704/275

(57) ABSTRACT

The device of the present invention synthesizes voices or the like with the image data when an image is taken, and can thereby obtain impressive images or prints with high added values. Furthermore, the present invention can also extract a voice of a specific speaker through a voice print decision and convert it to text, and can thereby improve the accuracy of text conversion.

### BACKGROUND OF THE INVENTION

1. Field of the Invention

The present invention relates to an imaging device and image output device, and more particularly, to an imaging device capable of recording voices as well as images and an image output device which outputs images captured by such an imaging device.

2. Description of the Related Art

Conventionally, a camera which can analyze an input voice, convert it to a character image and synthesize it with an image of an object has been developed (e.g., Japanese Patent Application Laid-Open No. 2003-348410). The camera disclosed in Japanese Patent Application Laid-Open No. 2003-348410 decides a main object area in an image and synthesizes a character image in an area other than the main object area.

### SUMMARY OF THE INVENTION

However, in the above described camera, there have been adverse influences, for example, voices of people other than an input voice of a main speaker and surrounding noise or the like are converted to characters or character conversion is not performed correctly.

Furthermore, the camera according to Japanese Patent Application Laid-Open No. 2003-348410 cannot distinguish one speaker's voice from another speaker's voice. Moreover, when a plurality of people appear in an image, simply laying out character images by avoiding the main object area results in a problem that it is difficult to identify a person who utters the voice.

The present invention has been implemented in view of such circumstances and it is an object of the present invention to provide an imaging device and image output device capable of selectively recording a specific speaker's voice, converting a voice to text for each speaker and lay out the text.

In order to attain the above described object, the imaging device according to a first aspect of the invention includes an image pickup device which takes an image of a speaker, a voice input device which inputs a voice of the speaker, a voice print registration device which registers a voice print of the speaker, a voice extraction device which filters the voice input by the voice input device and extracts the voice corresponding to the voice print registered in the voice print registration device, a text data generation device which converts the extracted voice to text data and a recording device which records the image taken by the image pickup device associated with the text data.

According to the imaging device of the first aspect of the invention, it is possible to filter voices of people other than the main speaker or noise, convert only voices of speakers whose voice prints are registered to text and add the text to an image. This can improve the accuracy of text conversion of the voice. Note that the voice input device according to the first aspect of the invention is, for example, a microphone for recording voices when an image is taken or recording media to which a voice file is input.

The imaging device according to a second aspect of the present invention is the first aspect of the invention, wherein the voice print registration device registers voice prints of a plurality of speakers associated with speaker identification information which identifies the speakers and when voices of the plurality of speakers are input, the text data generation device makes the text data distinguishable for each of the speakers. According to the imaging device of the second aspect of the present invention, text data can be created for each speaker.

The imaging device according to a third aspect of the present invention is the first or second aspect of the invention, further comprising an image/text synthesis device which synthesizes the image with text image data which is the text data converted to an image. According to the imaging device of the third aspect of the invention, images can be synthesized with text data.

The imaging device according to a fourth aspect of the present invention is the first to third aspect of the invention, wherein the image/text synthesis device changes at least one of a character font of the text image data, font size, color, background color, character decoration or column setting for each of the speakers. According to the imaging device of the fourth aspect of the invention, it is more easily visually recognizable who utters the word from text data.

The imaging device according to a fifth aspect of the present invention is the first to fourth aspect of the invention, further comprising an extracted voice specification device which selects the speaker identification information and specifies a speaker whose voice is to be extracted by the voice extraction device. According to the imaging device of the fifth aspect of the invention, the speaker's voice to be converted to text can be specified.

The imaging device according to a sixth aspect of the present invention is the first to fifth aspect of the invention, further comprising a speaker direction calculation device which calculates a direction in which the speaker who utters the voice is located based on the input voice, wherein the image/text synthesis device lays out the text image data on the image based on the direction in which the speaker is located.

According to the imaging device of the sixth aspect of the invention, it is possible to convert the words uttered by the speaker to text and dispose the text, for example, close to the image of the speaker based on the direction in which the speaker is located.

The imaging device according to a seventh aspect of the present invention is the sixth aspect of the invention, wherein the voice input device is made up of a plurality of microphones and the speaker direction calculation device calculates the direction in which the speaker is located based on differences in sound levels of voices input from the plurality of microphones. According to the imaging device of the seventh aspect of the invention, the speaker direction calculation device is limited.

The imaging device according to an eighth aspect of the present invention is the first to seventh aspect of the invention, further comprising a text editing device which edits the text data.

According to the imaging device of the eighth aspect of the present invention, when there are errors in the text due to misrecognition of voices or the like, the text data can be edited.

The image output device according to a ninth aspect of the present invention comprises a data input device which inputs an image and text data associated with the image, an image/text synthesis device which changes, when the text data is converted to text in such a way that words uttered by a plurality of speakers are made distinguishable for each of the speakers, at least one of a character font of the text image data, font size, color, background color, character decoration or column setting for each of the speakers, synthesizes the text image data with the image to create a synthesized image and an output device which outputs the synthesized image.

According to the image output device of the ninth aspect of the invention, it is more easily visually recognizable who utters the words from the appearance of the text of the synthesized image displayed on the print or the screen.

The image output device according to a tenth aspect of the present invention comprises a data input device which inputs an image and text data associated with the image, an image/text synthesis device which lays out, when the text data includes information on a direction in which the speaker is located when an image is taken, the text image data on the image based on the direction in which the speaker is located to create a synthesized image and an output device which outputs the synthesized image.

According to the image output device of the tenth aspect of the invention, it is more easily visually recognizable who utters the words from the arrangement of the text on the synthesized image on the print or screen.

The image output device according to an eleventh aspect of the present invention is the ninth or tenth aspect of the invention, further comprising a text editing device which edits the text data.

According to the image output device of the eleventh aspect of the invention, when text is added, deleted or text contains errors or the like, the text data can be edited.

The image output device according to a twelfth aspect of the present invention is the ninth to eleventh aspect of the invention, wherein the output device is a printer which prints the image. The twelfth aspect of the invention limits the output device of the ninth to eleventh aspect of the invention to a printer.

The present invention synthesizes voices or the like with the image data when an image is taken, and can thereby obtain impressive images or prints with high added values. Furthermore, the present invention can also extract a voice of a specific speaker through a voice print decision and convert it to text, and can thereby improve the accuracy of text conversion.

### BRIEF DESCRIPTION OF THE DRAWINGS

FIGS. 1A to 1C are outside views of an imaging device according to an embodiment of the present invention;

FIG. 2 is a block diagram showing an internal structure of an imaging device according to a first embodiment of the present invention;

FIG. 3 is a flow chart showing a method of registering a voice print;

FIG. 4 is a flow chart showing processes when an image is taken in a recording-during-image-taking mode;

FIG. 5 schematically shows analysis of voices;

FIG. 6 is a flow chart showing processes when an image is taken in a recording-before-image-taking mode;

FIG. 7 is a flow chart showing processes when an image is taken in a recording-after-image-taking mode;

FIG. 8 is a flow chart showing processes when a voice recording mode is OFF;

FIG. 9 is a flow chart showing processes when voice data or text data is synthesized with an image;

FIG. 10 is a block diagram showing an internal structure of an imaging device according to a second embodiment of the present invention;

FIGS. 11A and 11B illustrate examples of a synthesized image;

FIG. 12 is a block diagram showing an internal structure of an image output device (printing device) according to an embodiment of the present invention; and

FIG. 13 is a flow chart showing a printing operation by the image output device (printing device) according to the embodiment of the present invention.

### DETAILED DESCRIPTION OF THE PREFERRED EMBODIMENTS

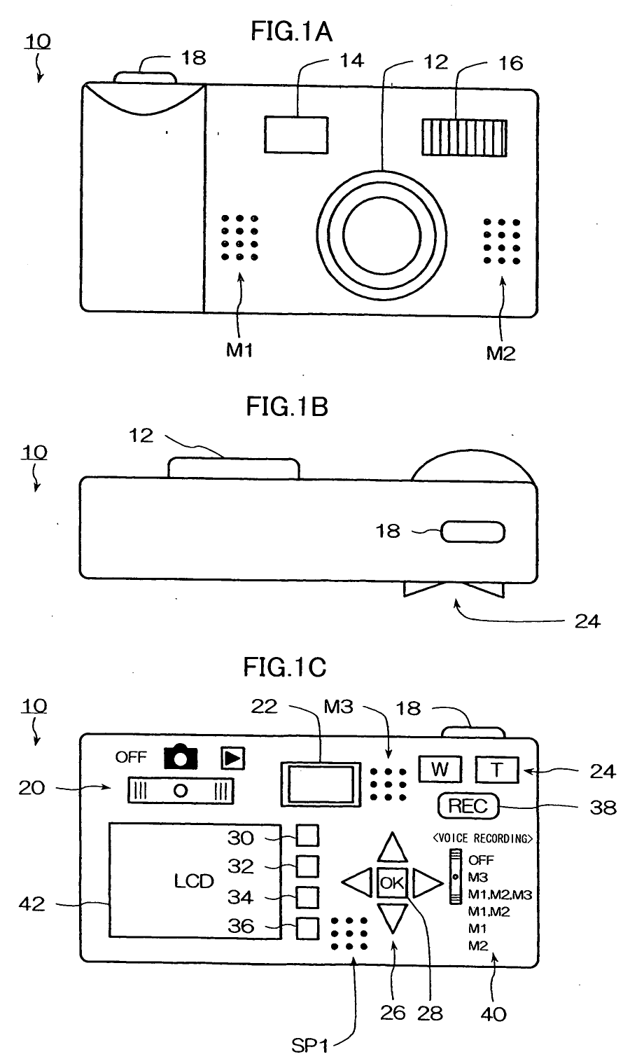

With reference now to the attached drawings, preferred embodiments of an imaging device and image output device according to the present invention will be explained below. FIGS. 1A to 1C are outside views of an imaging device according to an embodiment of the present invention. FIG. 1A is a front view of the imaging device, FIG. 1B is a top view and FIG. 1C is a rear view. An imaging device 10 shown in FIGS. 1A to 1C is a digital camera which electronically takes still images or moving images of an object.

As shown in FIG. 1A, a lens 12, a finder window 14, a stroboscopic light-emitting section 16, a first microphone M1 and a second microphone M2 are exposed on the front of the imaging device (digital camera) 10. Furthermore, as shown in FIG. 1B, a shutter release button 18 is disposed on the top face of the imaging device 10.

The shutter release button 18 is constructed to operate in two stages; in a half-depressed state (S1=ON) in which the shutter release button 18 is slightly depressed and held, auto focusing (AF) and auto exposure control (AE) are activated to lock AF and AE and in a fully-depressed (S2=ON) state in which the shutter release button 18 is further depressed from the half-depressed state, image taking is carried out.

As shown in FIG. 1C, on the rear of the imaging device 10 are a power switch 20, a finder 22, a zoom switch 24, a multi-function switch (cross button 26 and OK button 28), a menu switch 30, a stroboscopic mode switch 32, a self-timer mode switch 34, a deletion button 36, a recording switch 38, a voice recording mode setting switch 40, a liquid crystal monitor (LCD) 42, a speaker SP1 and a third microphone M3 or the like.

The power switch 20 is a slide switch also functioning as a mode setting switch. When a knob is slid to the right direction, an “OFF mode” in which power of the imaging device 10 is turned OFF, a “camera mode” for image taking and a “play mode” in which images taken are reproduced are set one by one. The zoom switch 24 is a switch for setting a zoom position.

The cross button 26 is a multifunctional operation section which can enter commands in four directions of up, down, left and right. The left and right buttons function as a 1-frame backward feed button and a 1-frame advance button in the play mode, and the up and down buttons are used as zoom buttons to adjust magnification of a reproduction/zoom function or the like. Furthermore, the cross button 26 also functions as an operation button to select a menu item from a menu screen displayed on the liquid crystal monitor 42 or select setting items in various menus. A selection of a menu item or the like by the cross button 26 is confirmed by depressing the OK button 28 at the center.

The menu switch 30 is used, for example, to change a normal screen in each mode to the menu screen. The stroboscopic mode switch 32 is a switch to make a setting as to whether stroboscopic light is emitted or not when images are taken. The self-timer mode switch 34 is a switch used to perform image taking using a self-timer and designed to allow image taking in a self-timer mode by being depressed before depressing the shutter release button 18. The deletion button 36 is a switch to erase images being reproduced by being depressed in a play mode.

The recording switch 38 is a switch to control the start and end of voice recording. Recording starts when the recording switch 38 is depressed and recording is stopped when the recording switch 38 is depressed during recording. The voice recording mode setting switch 40 is a slide switch to specify a microphone (microphone M1 to M3, and a combination thereof) used to perform recording.

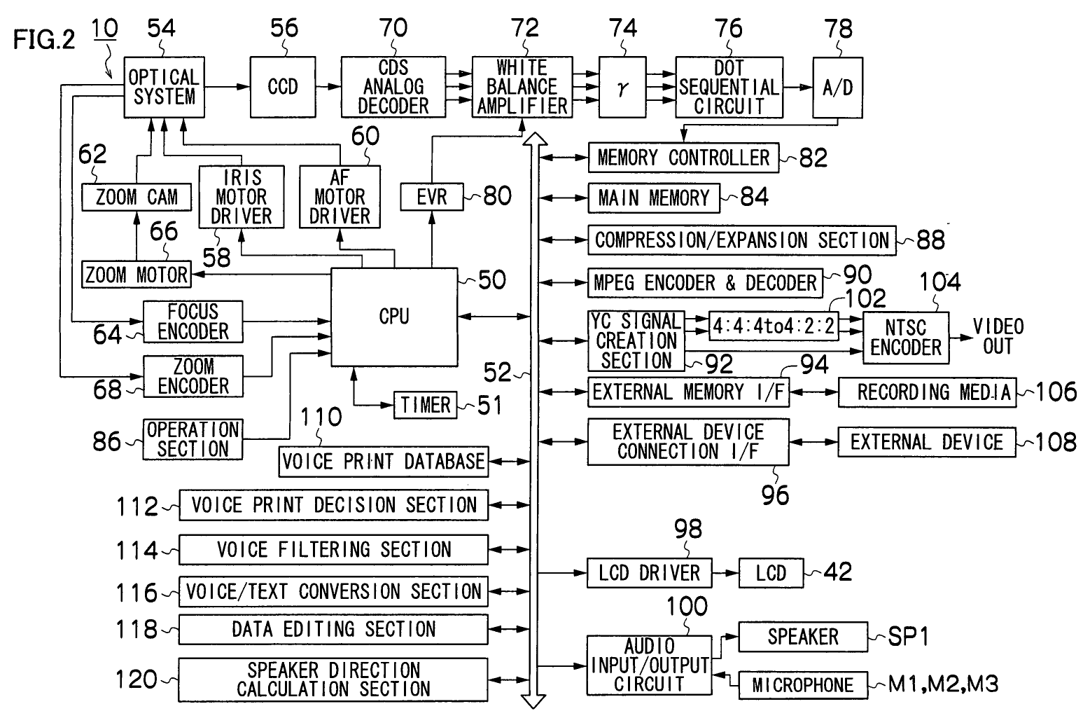

The liquid crystal monitor (LCD) 42 can be used as an electronic finder to confirm an angle of view when an image is taken and can also display a preview of an image captured and a reproduced image read from a recording media (reference numeral 106 in FIG. 2) loaded in the imaging device 10 or the like. Furthermore, a selection of the menu and setting of various setting items in each menu using the cross button 26 are also performed using the display screen of the liquid crystal monitor 42. Furthermore, the liquid crystal monitor 42 also displays information such as the number of frames that can be taken (maximum image taking time for a moving image), numbers of frames reproduced, presence/absence of stroboscopic light emission, macro mode, recording quality and number of pixels.

FIG. 2 is a block diagram showing the internal structure of the imaging device according to the first embodiment of the present invention. The imaging device 10 shown in FIG. 2 is provided with a CPU 50 and a timer 51. The CPU 50 is a centralized control section which controls various blocks in the imaging device 10. Reference numeral 52 in FIG. 2 is a data bus.

The imaging device 10 is provided with an optical system 54 including a lens (reference numeral 12 in FIGS. 1A and 1B) and a diaphragm or the like, and an image pickup element (CCD) 56 as an image pickup section (imaging device). An iris motor driver 58, an AF motor driver 60 and a zoom cam 62 are connected to the optical system 54.

The iris motor driver 58 drives an iris motor which displaces the diaphragm provided inside the optical system 54.

The AF motor driver 60 drives an auto focus (AF) motor which displaces a focusing lens. Positional information on the focusing lens is encoded by a focus encoder 64 and sent to the CPU 50.

The zoom cam 62 is driven by the zoom motor 66 to cause a zoom lens to displace. Positional information on the zoom lens is encoded by a zoom encoder 68 and sent to the CPU 50.

A CDS analog decoder 70, a white balance amplifier 72, a γ correction circuit 74, a dot sequential circuit 76 and an A/D converter 78 are provided on the output side of the CCD 56 to carry out various types of processing on an image pickup signal from the CCD 56 and output a digital image signal. Furthermore, an electronic volume (EVR) 80 is connected to the white balance amplifier 72 to control the gain of the white balance amplifier 72. The output of the A/D converter 78 is transmitted to a main memory 84 via a memory controller 82 and the image data of the object whose image has been captured is stored in the main memory 84.

Furthermore, an operation section 86 is connected to the CPU 50. The operation section 86 includes operation members such as the shutter release button 18, power switch 20, zoom switch 24, multi-function switch (cross button 26 and OK button 28), menu switch 30, stroboscopic mode switch 32, self-timer mode switch 34, deletion button 36, recording switch 38 and voice recording mode setting switch 40 shown in FIG. 1A.

Furthermore, a compression/expansion section 88, an MPEG encoder & decoder 90, a YC signal creation section 92, an external memory interface (external memory I/F) 94, an external device connection interface (external device connection I/F) 96, a monitor (LCD) driver 98 and an audio input/output circuit 100 are connected to the data bus 52.

The compression/expansion section 88 carries out compression processing and expansion processing of JPEG system image data or the like. The MPEG encoder & decoder 90 encodes MPEG system moving image data and decodes moving image data subjected to MPEG compression/encoding. The YC signal creation section 92 separates and generates a brightness signal Y for generating an NTSC system video signal and color difference signals R−Y, B−Y. The YC signal creation section 92 is followed by a color conversion section 102 which converts the ratio between the brightness signal Y and color difference signals R−Y, B−Y from 4:4:4 to 4:2:2 and an NTSC encoder 104 which generates and outputs an NTSC system video signal.

The above described compression/expansion section 88, MPEG encoder & decoder 90, YC signal creation section 92, color conversion section 102 and NTSC encoder 104 may also be constructed of a dedicated signal processing circuit or realized through software processing by the CPU 50 or constructed of a signal processing circuit having a function of a DSP or the like.

A liquid crystal monitor (LCD) 42 is connected to the monitor (LCD) driver 98 to display a through moving image of an object whose image is to be taken, recorded image after image taking, various states and setting screens or the like on a screen of the liquid crystal monitor 42. The speaker SP1 and microphones M1, M2 and M3 are connected to the above described audio input/output circuit 100 to reproduce and output various types of operating sound when an image is taken, and input a voice signal when a moving image is taken.

In the imaging device 10 constructed in this way, an image of an object is formed by the optical system 54 on the image pickup plane of the CCD 56, where the object image is photoelectrically converted. The image pickup signal output from the CCD 56 is subjected to correlative double sampling by the CDS analog decoder 70, the noise component thereof is canceled and then the white level of a color image signal is adjusted by the white balance amplifier 72. Then, the signal is subjected to γ correction by the γ correction circuit 74, passed through the dot sequential circuit 76, A/D-converted by the A/D converter 78 and output as digital image data. The digital image data is stored in the main memory 84 via the memory controller 82.

The digital image data is displayed on a screen of the liquid crystal monitor 42 as the object image being taken. The user depresses the shutter release switch 18 to turn on the switch (S2=ON) while watching the object image and takes a still image or moving image of the object. The image data after image taking is subjected to compression processing by the compression/expansion section 88 and subjected to MPEG compression/encoding by the MPEG encoder & decoder 90. The digital image data processed in this way is sent to an external recording media 106 via the external memory I/F 94 or an external device 108 such as a personal computer via the external device connection I/F 96 and recorded therein. Furthermore, the image data captured is passed through the YC signal creation section 92, color conversion section 102, NTSC encoder 104, converted to an NTSC video signal and output as a video signal.

Furthermore, the imaging device 10 is provided with a voice print database 110, a voice print decision section 112, a voice filtering section 114, a voice/text conversion section 116, a data editing section 118 and a speaker direction calculation section 120.

The voice print database 110, is a functional section which registers speakers' voice prints. The voice print decision section 112 is a functional section which decides voices input from the microphones M1, M2 and M3 match voice prints registered in the voice print database 110 or not. The voice filtering section 114 is a functional section which filters voices input from the microphones M1, M2 and M3 and extracts the voices that match the voice prints registered in the voice print database 110.

The voice/text conversion section 116 is a functional section which carries out voice recognition processing on the voices extracted by the voice filtering section 114 and converts them to text data. The text data generated by the voice/text conversion section 116 is recorded in the recording media 106.

The data editing section 118 is a functional section which edits the text data generated by the voice/text conversion section 116 and includes an editor to edit and lay out the text data based on an input from the external device 108 connected via the external device connection I/F 96 (personal computer, keyboard and monitor or the like).

The speaker direction calculation section 120 is a functional section which calculates the direction in which the speaker is located based on differences in sound levels of the same voice captured from the microphones M1, M2 and M3.

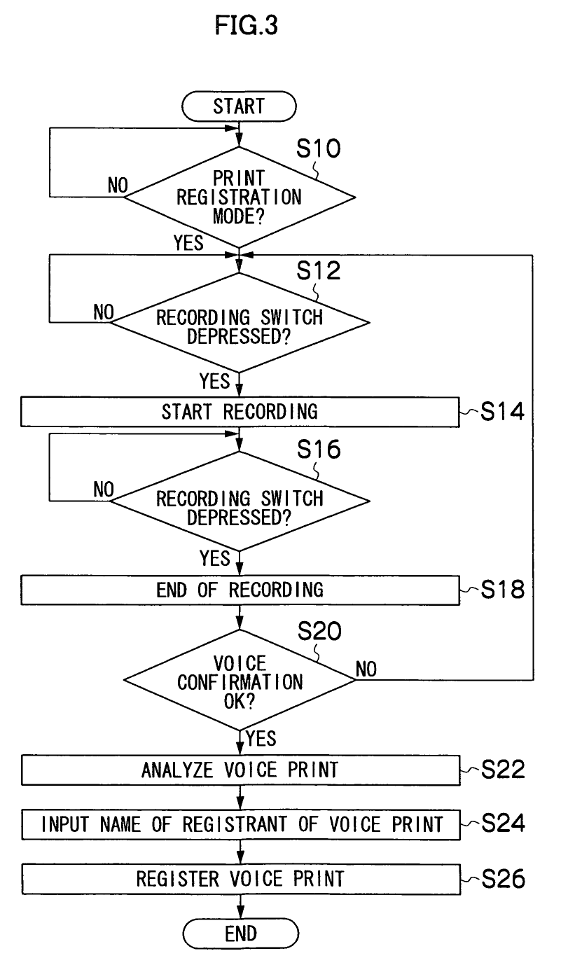

Next, the method of registering a voice print in the imaging device 10 will be explained. FIG. 3 is a flow chart showing the method of registering a voice print.

First, by operating the menu switch 30 and multi-function switch, the CPU 50 detects that a voice print registration mode is set (step S10). Next, when the CPU 50 detects that the recording switch 38 is depressed (step S12), the microphone (at least one of the M1, M2 and M3) selected by the voice recording mode setting switch 40 starts recording (step S14). In step S14, for example, the speaker reads and records predetermined words and sentences or the like for recognition of a voice print. When the CPU 50 detects that the recording switch 38 is depressed (step S16), recording is finished (step S18).

Next, the voice recorded in the above described step is reproduced and a selection screen for selecting whether recording is performed again or the reproduced voice is registered is displayed (step S20). When, for example, the speaker does not like the reproduced voice in step S20 and selects starting recording over again on the selection screen, the CPU 50 detects the operation on this selection screen and the process returns to step S12. On the other hand, when the speaker selects registering the reproduced voice in step S20, the voice print decision section 112 analyzes the voice print (step S22). Then, a screen for inputting the name of the registrant of the voice print is displayed, the CPU 50 recognizes the name of the registrant of the input voice print (step S24) and the voice print is registered in the voice print database 110 associated with the name of the registrant of the voice print (step S26).

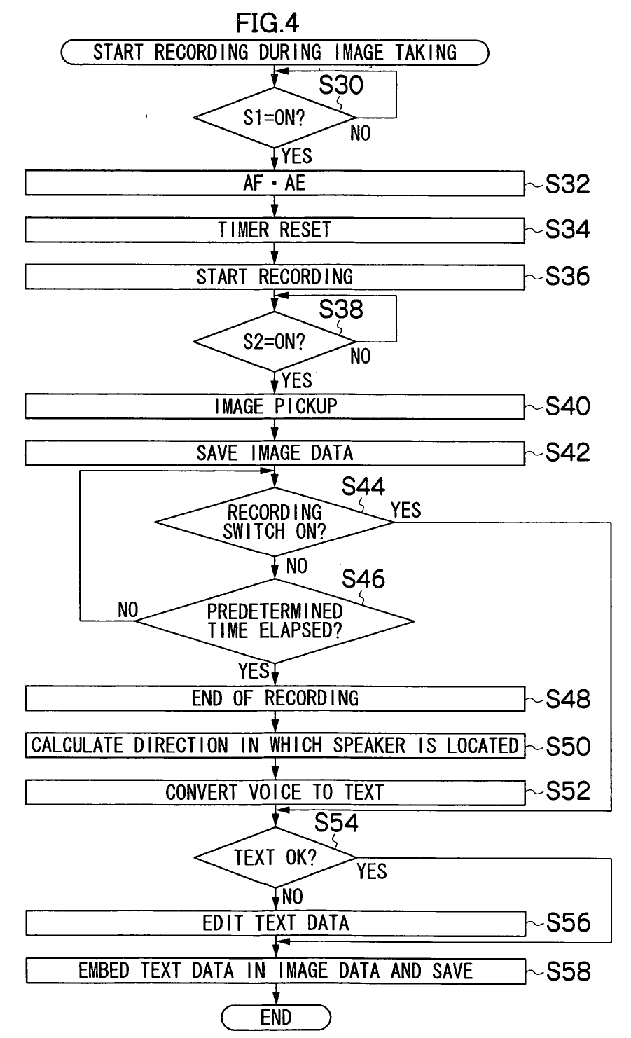

When an image is taken in a voice recording mode, the imaging device 10 of this embodiment makes it possible to select whether a voice is input before or after image taking through a menu selection. These will be referred to as a recording-during-image-taking mode, recording-before-image-taking mode and recording-after-image-taking mode, respectively. First, the recording-during-image-taking mode will be explained. FIG. 4 is a flow chart showing processing when an image is taken in the recording-during-image-taking mode.

First, when the shutter release button 18 is half depressed (S1=ON) (step S30), AF and AE are locked as described above (step S32). Then, the timer 51 is reset (step S34) and recording is started by the microphone selected by the voice recording mode setting switch 40 (at least one of M1, M2 and M3, simply referred to as “microphone M” in the following explanations) (step S36). This recording time is counted by the timer 51. Furthermore, in step S36, the voice captured from the microphone M is analyzed and compared with the voice prints registered in the voice print database 110 by the voice print decision section 112.

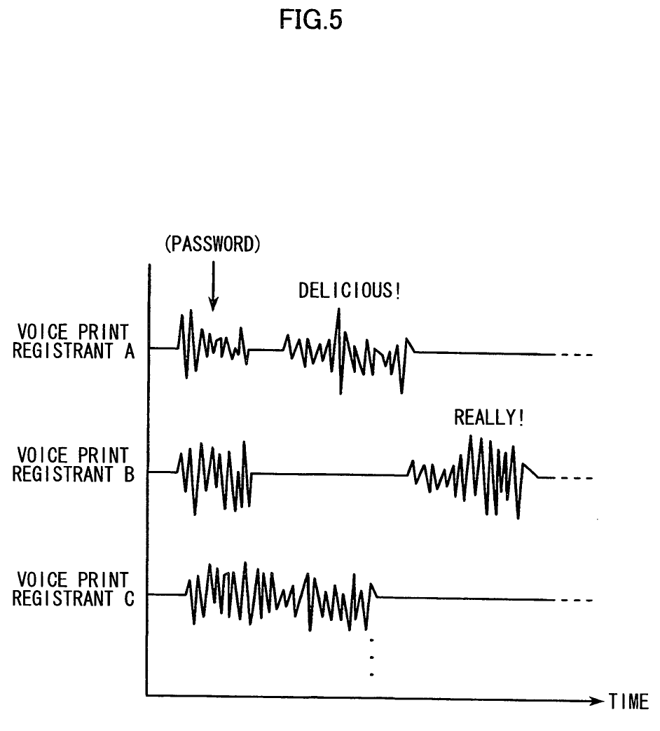

FIG. 5 schematically shows a voice analysis. As shown in FIG. 5, the voice captured from the microphone M is analyzed by the voice print decision section 112, the voice registered in the voice print database 110 is extracted by the voice filtering section 114, only the extracted voice is recorded, the name of the registrant of the voice print is associated with the voice data and saved (e.g., voice prints of different registrants are saved in different voice files).

Note that the present embodiment may also be adapted in such a way that each speaker utters a predetermined password (for example, name) at the start of recording in step S36 and recognition of the speaker's voice corresponding to the password is started.

Returning to the explanation of the flow chart in FIG. 4, when the shutter release button 18 is fully depressed (S2=ON) (step S38), an image is captured (step S40) and image data is saved in the recording media 106 (step S42). When the recording switch 38 is turned ON (step S44), recording is finished (step S48). Furthermore, even when the recording switch 38 is not turned ON, if the time elapsed from the start of recording counted by the timer 51 exceeds a predetermined time (step S46), the recording is finished (step S48).

Next, the speaker direction calculation section 120 calculates the direction in which the speaker is located from the recorded voice (step S50) and the recorded voice is converted to text by the voice/text conversion section 116 (step S52). When the conversion of the voice to text is completed, the text data is displayed on a personal computer or a monitor or the like connected via the monitor 42 or external device connection I/F 96 and a selection screen for selecting whether the text data is to be edited or not is displayed (step S54). When editing of the text data is selected in step S54, the text data is edited using the personal computer and keyboard or the like connected via the operation section 86 or external device connection I/F 96 (step S56), the text data and information on the direction in which the speaker is located (information on the speaker direction) are embedded in the image data saved in step S42 and saved in the recording media 106 (step S58). On the other hand, when the saving of the text data is selected in step S54, the text data is embedded in the image data without being edited together with the speaker direction information and saved in the recording media 106 (step S58).

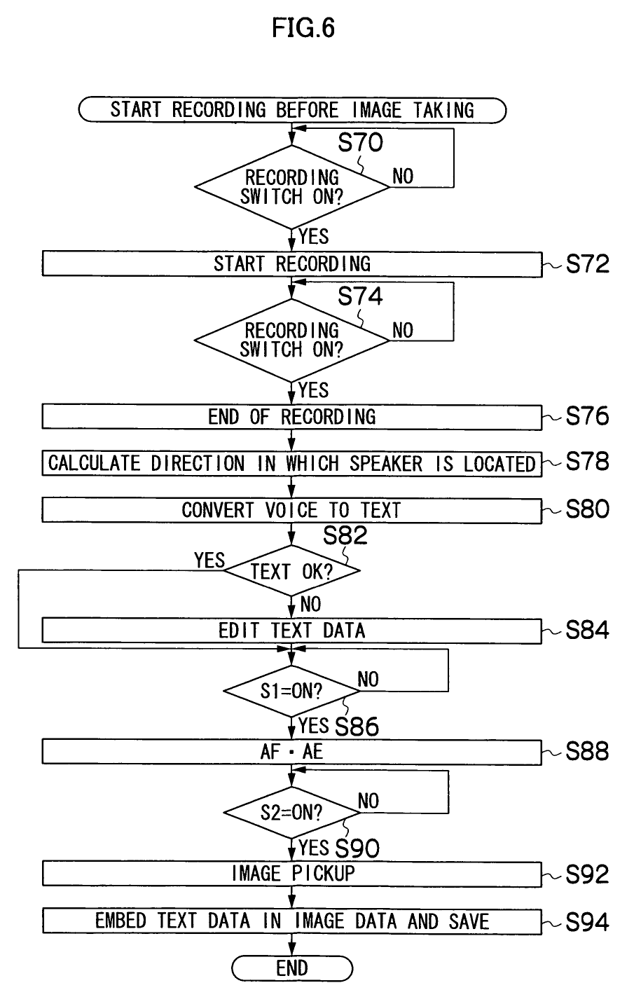

Next, the recording-before-image-taking mode will be explained. FIG. 6 is a flow chart showing processes when an image is taken in the recording-before-image-taking mode.

First, when the recording switch 38 is turned ON (step S70), recording is started by the microphone M selected by the voice recording mode setting switch 40 (step S72). When the recording switch 38 is turned ON (step S74), the recording is finished (step S76). Note that in step S72 as in the case of step S36 above, the voice registered in the voice print database 110 is extracted by the voice filtering section 114 from the voice captured from the microphone M and recorded.

Next, the direction in which the speaker is located is calculated by the speaker direction calculation section 120 from the recorded voice (step S78) and the recorded voice is converted to text by the voice/text conversion section 116 (step S80). When the conversion from voice to text is completed, a selection screen for selecting whether text data is edited or not is displayed as in the case of step S54 above (step S82). In step S82, when editing of the text data is selected, the text data is edited (step S84) and saved in the recording media 106. On the other hand, when saving of the text data is selected in step S82, the text data is not edited and saved in the recording media 106.

Next, when the shutter release button 18 is half depressed (S1=ON) (step S86), AF and AE are locked as described above (step S88). When the shutter release button 18 is fully depressed (S2=ON) (step S90), an image is captured (step S92). Next, the above described text data and speaker direction information are embedded in the image data and saved in the recording media 106 (step S94).

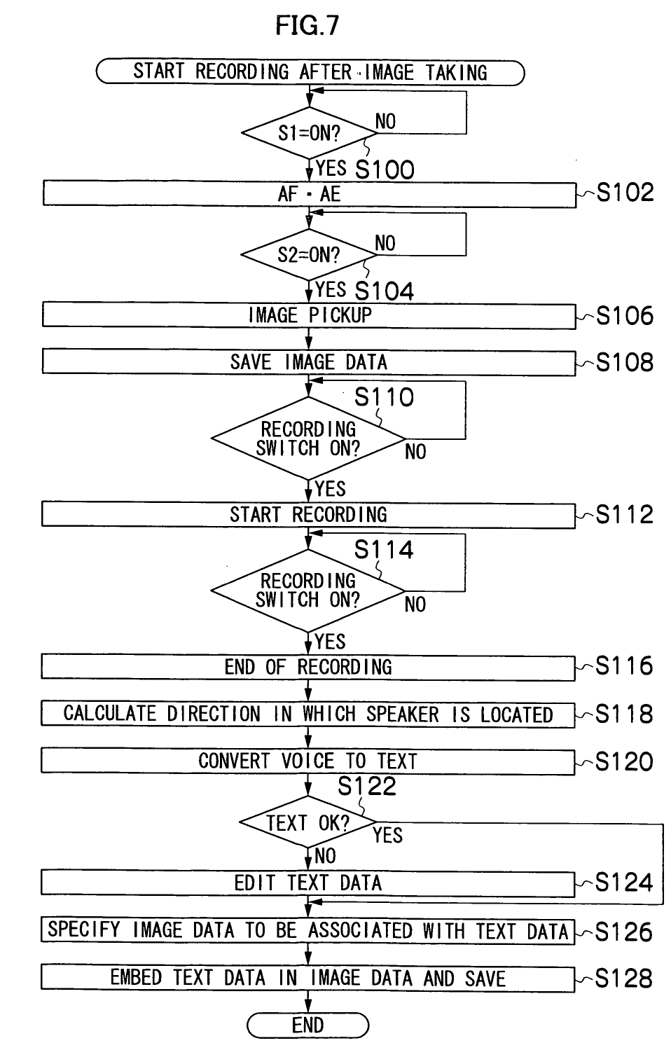

Next, the recording-after-image-taking mode will be explained. FIG. 7 is a flow chart showing processes when an image is taken in a recording-after-image-taking mode.

First, when the shutter release button 18 is half depressed (S1=ON) (step S100), AF and AE are locked as described above (step S102). When the shutter release button 18 is fully depressed (S2=ON) (step S104), an image is captured (step S106) and the image data is saved in the recording media 106 (step S108).

Next, when the recording switch 38 is turned ON (step S110), recording is started by the microphone M selected by the voice recording mode setting switch 40 (step S1112). When the recording switch 38 is turned ON (step S114), recording is finished (step S116). In step S112 as in the case of step S36 above, the voice registered in the voice print database 110 is extracted by the voice filtering section 114 from the voice captured from the microphone M and recorded.

Next, the direction in which the speaker is located is calculated by the speaker direction calculation section 120 from the recorded voice (step S118) and the recorded voice is converted to text by the voice/text conversion section 116 (step S120). When the conversion from voice to text is completed, a selection screen for selecting whether the text data is edited or not is displayed as in the case of step S54 above (step S122). When editing of the text data is selected in step S122, the text data is edited (step S124) and the process moves to step S126. On the other hand, when saving of the text data is selected in step S122, the text data is not edited and the process moves to step S126.

Next, the image data saved in the recording media 106 is read. Then, image data to be associated with the above described text data is specified by the cross button 26 or the like (step S126), the above described text data and speaker direction information are embedded in the specified image data and saved in the recording media 106 (step S128).

Note that in the recording-before-image-taking mode in FIG. 6 and in the recording-after-image-taking mode in FIG. 7, the recording time may also be controlled by the timer 51 as in the case of the recording-during-image-taking mode in FIG. 4.

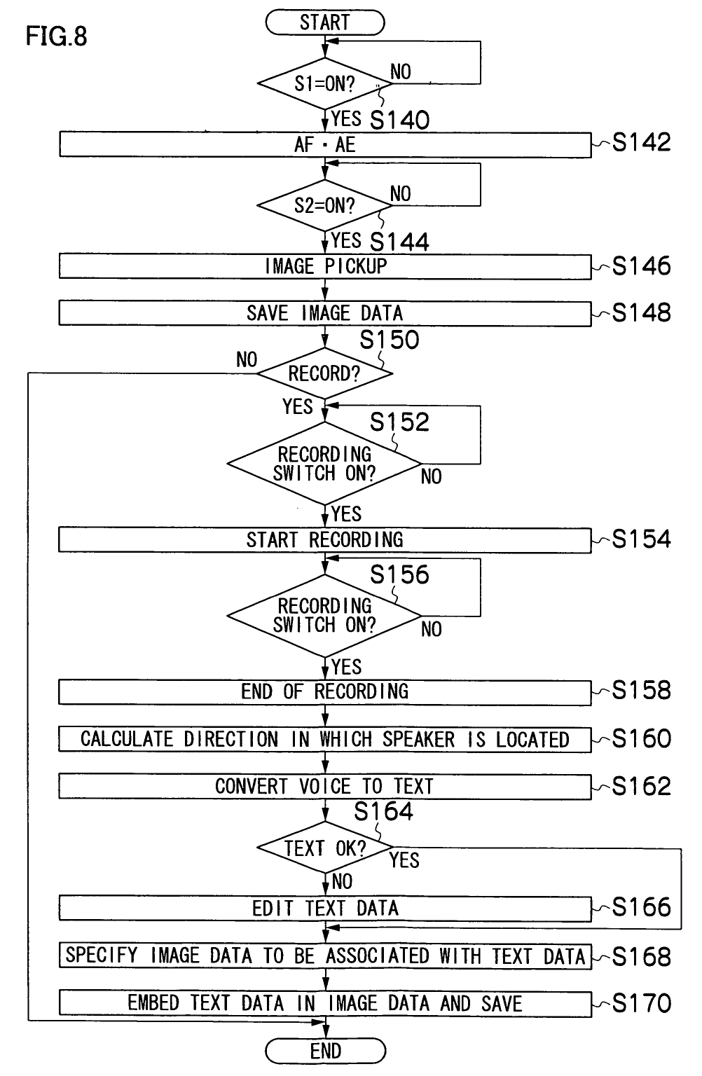

Furthermore, the imaging device 10 of this embodiment can select whether recording is performed after an image is taken or not even when the voice recording mode is OFF. FIG. 8 is a flow chart showing processes when the voice recording mode is OFF.

First, when the shutter release button 18 is half depressed (S1=ON) (step S140), AF and AE are locked as described above (step S142). Next, when the shutter release button 18 is fully depressed (S2=ON) (step S144), an image is captured (step S146) and image data is saved in the recording media 106 (step S148).

Next, a selection screen for selecting whether recording is performed or not is displayed on the liquid crystal monitor 42 (step S150). When no recording is selected in step S150, the process ends. On the other hand, when recording is selected in step S150, the voice recording mode is automatically turned ON. In this case, a screen urging the user to select a microphone to be used by the voice recording mode setting switch 40 is displayed on the liquid crystal monitor 42.

Then, when the microphone M to be used is selected by the voice recording mode setting switch 40 and the recording switch 38 is turned ON (step S152), recording is started by the microphone M selected by the voice recording mode setting switch 40 (step S154). Note that it is also possible to make a setting such that recording using a predetermined microphone is automatically allowed irrespective of the slide position of the voice recording mode setting switch 40. When the recording switch 38 is turned ON after recording is started (step S156), the recording is finished (step S158). In step S154 as in the case of step S36 above, the voice registered in the voice print database 110 is extracted by the voice filtering section 114 from the voice captured from the microphone M and recorded. Following steps S160 to S170 are the same as steps S118 to S128 in FIG. 7, and therefore explanations thereof will be omitted.

According to the imaging device 10 of this embodiment, it is possible to selectively convert a voice of a specific speaker whose voice print is registered beforehand in the voice print database 110 to text and record the voice. It is further possible to convert the voice of each speaker whose voice print is registered to text and lay out the text in the image to make it easier to understanding who utters the word.

In FIG. 4 and FIGS. 6 to 8, a voice is analyzed during recording and the voice extracted by the voice filtering section 114 is recorded, but it is also possible to analyze the voice when text data is generated (step S52 in FIG. 4, step S80 in FIG. 6, step S120 in FIG. 7 and step S162 in FIG. 8) without carrying out filtering of the voice during recording and convert only the voice of the voice print registrant to text.

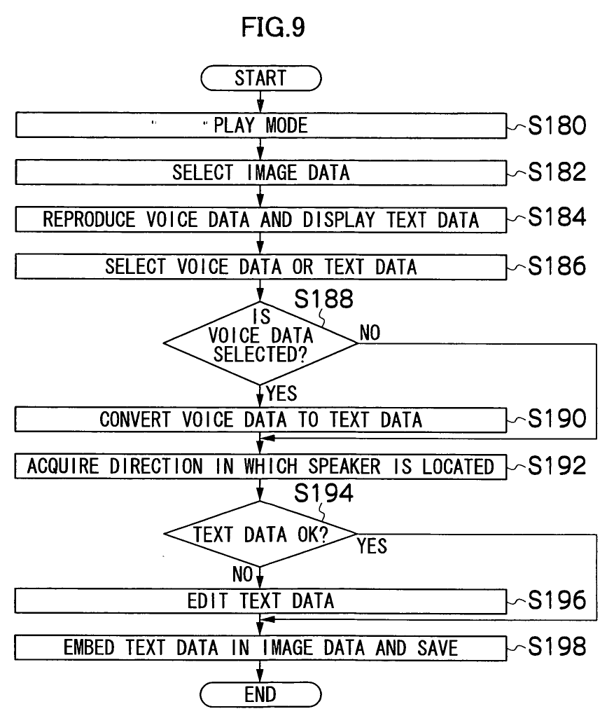

Furthermore, the imaging device 10 of this embodiment can embed voice data and text data created beforehand in an image. FIG. 9 is a flow chart showing processes when voice data or text data is embedded in image data.

First, a play mode for reproducing an image is set by the power switch 20 (step S180) and image data is selected using the cross button 26 or the like (step S182). Next, voice data is reproduced or text data is displayed (step S184) and voice data or text data to be embedded in the image data is selected (step S186).

When the text data is selected in step S186 (step S188), the process moves to step S192. On the other hand, when the voice data is selected in step S186 (step S188), the selected voice data is converted to text data by the voice/text conversion section 116 (step S190). The speaker direction calculation section 120 calculates the direction in which the speaker is located when an image is taken from voice data (step S192).

Next, the text data is displayed on the monitor 42 or the like and a confirmation screen for confirming whether the text data is edited or not is displayed (step S194). In step S194, when editing of the text data is selected, the text data is edited (step S196), the text data together with speaker direction information is embedded in the image data selected in step S182 and saved in the recording media 106 (step S198). On the other hand, when saving of the text data is selected in step S194, the text data is not edited but embedded together with the speaker direction information in the image data and saved in the recording media 106 (step S198).

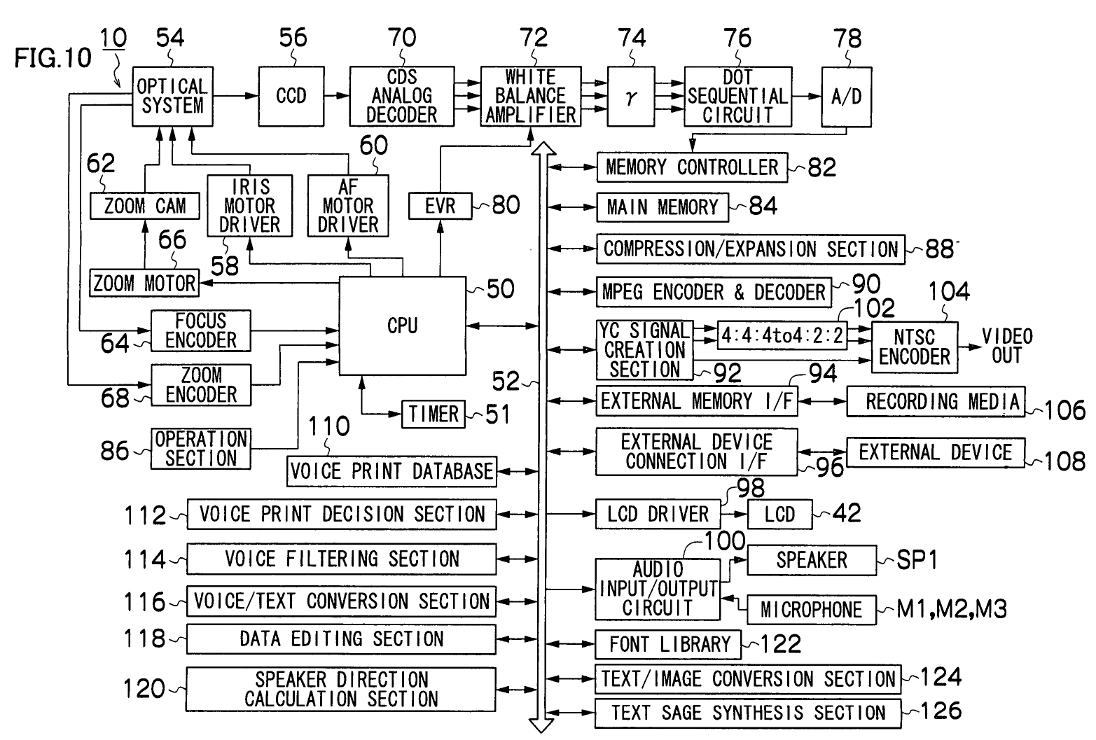

Next, an imaging device according to a second embodiment of the present invention will be explained, FIG. 10 is a block diagram showing the internal structure of the imaging device according to a second embodiment of the present invention. The imaging device 10 shown in FIG. 10 is provided with a font library 122, a text/image conversion section 124 and a text image synthesis section 126.

The font library 122 stores various character fonts. When there are a plurality of speakers, the voice/text conversion section 116 references the font library 122, changes the font of the text, font size, color, background color or character decoration (e.g., underline, boldface, italic type, shading, fluorescent pen, box character, character rotation, shaded character, outline type) for every speaker to provide a layout so as to make the correspondence between text and the speaker visually distinguishable. The font set by the voice/text conversion section 116 can be changed by the data editing section 118.

The text/image conversion section 124 converts text data to text image data. This text image data is text data converted into the same file format as that of image data to be embedded. The text image synthesis section 126 synthesizes this text image data and image data to create a synthesized image based on the direction of the speaker calculated by the speaker direction calculation section 120.

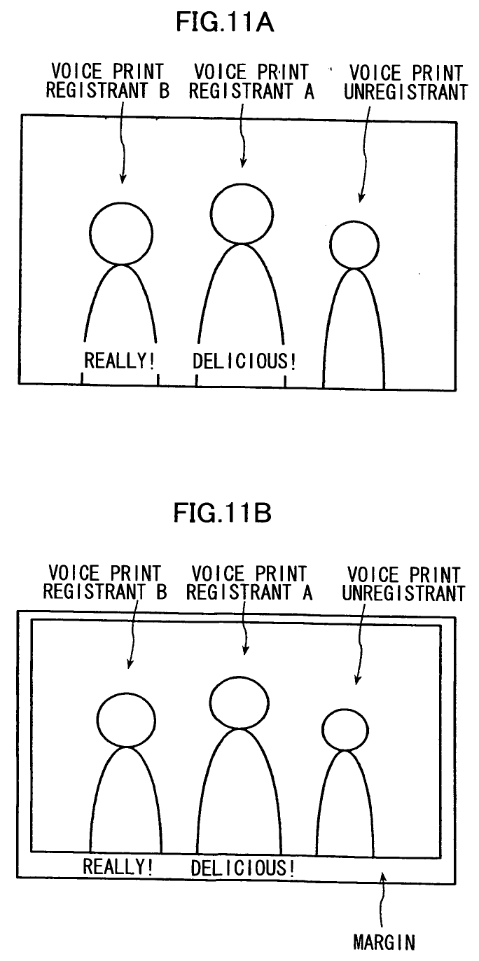

FIGS. 11A and 11B illustrate examples of a synthesized image. The voice print registrants A, B and voice print non-registrant shown in FIGS. 11A and 11B correspond to those in FIG. 5. As shown in FIGS. 11A and 11B, the text image data corresponding to the voices of voice print registrants A, B are laid out based on the speaker direction information, for example, the voice of the voice print registrant B who is on the left when viewed from the imaging device 10 is laid out on the left in the image and the voice of the voice print registrant A who is in the center is laid out close to the center. On the other hand, the voice of the user recorded by the microphone M3 is laid out at such a position that does not overlap with the object, on the back or the like.

Furthermore, as shown in FIG. 11A, the text image data may be embedded in an image or may be disposed in the margin of the image as shown in FIG. 11B. The layout of the above described text image data can be edited using a personal computer and keyboard or the like connected via the operation section 86 and external device connection I/F 96.

According to the imaging device 10 of the present embodiment, text data is converted to text image data having different appearances (font, font size, color or the like) for different speakers and synthesized, and therefore the correspondence between text and speakers can be distinguished visually more easily.

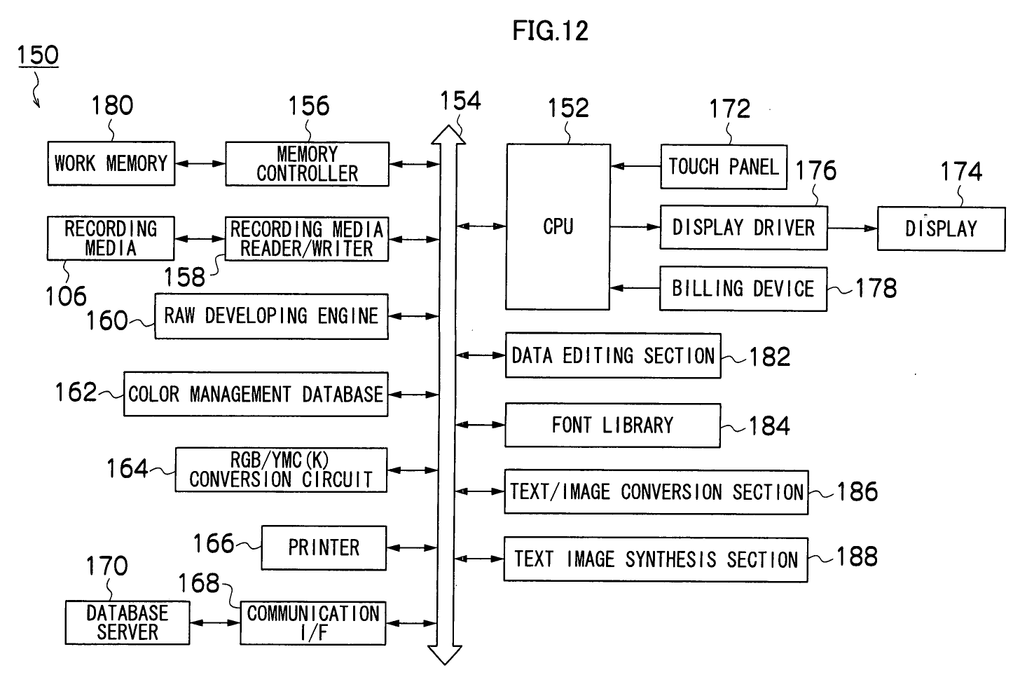

Next, the image output device of the present invention will be explained. FIG. 12 is a block diagram showing the internal structure of an image output device according to an embodiment of the present invention. The image output device 150 (hereinafter referred to as “printing device”) shown in FIG. 12 is placed in a store such as a DPE store (photo service store) and a consumer electronics mass merchandiser, for example, and used by general users and is particularly suitable for printing images taken by the above described imaging device 10.

A CPU 152 in the printing device 150 is connected to a memory controller 156, a recording media reader/writer 158, a RAW developing engine 160, a color management database 162, an RGB/YMC (K) conversion circuit 164 and a printer 166 via a bus 154. A communication interface (communication I/F) 168 in FIG. 12 is an interface to communicate with a database server 170 to control the printing device 150. The database server 170 is installed in a store where the printing device 150 is installed or in a control center connected to the printing device 150 via a communication line and controls a print history and sales data or the like of each printing device 150.

Furthermore, a touch panel 172, a display driver 176 for driving a display 174 and a billing device 178 are also connected to the CPU 152.

Image data stored in various types of recording media 106 (see FIG. 2 and FIG. 10) of the imaging device 10 is read by the recording media reader/writer 158 and temporarily stored in the work memory 180 via the memory controller 156.

The touch panel 172 is placed on the display 174 and functions as an input device whereby the user touches and selects an image to be printed from images displayed on the display 174 or specifies the number of prints, size of print sheet or magnification of print. The billing device 178 collects cash using, for example, a coin machine and performs change counting processing in accordance with the number of prints specified by the touch panel 173.

When the image data read from the recording media is RAW data (unprocessed image data output from an image pickup element such as CCD), the RAW developing engine 160 carries out linear matrix processing, white balance processing, synchronization processing, or the like on the RAW data and generates data that can be output to the display 174 or the like.

The color management database 162 stores data for correcting a color difference between the image displayed on the display 174 and the image printed by the printer 166 and reproducing the image with the same colors.

The RGB/YMC(K) conversion circuit 164 converts R, G, B data subjected to various types of image processing to Y, M, C, (K) (yellow, magenta, cyan, (black)) data and outputs this converted Y, M, C, (K) data to the printer 166.

As the printer 166, for example, a printing system using a TA (thermo auto chrome; registered trade mark) system can be used. A printer based on the TA system colors color printing paper having coloring layers of C, M, Y (hereinafter referred to as “TA paper”) itself with heat and fixes the colors with irradiation of light having a predetermined wavelength and is provided with a device which carries TA paper, thermal head, fixing lamp or the like. When a color image is printed on TA paper, the TA paper is carried first, the thermal head is controlled with Y data, the yellow layer of the TA paper is colored and then the coloring of yellow is fixed with the fixing lamp. Coloring of the magenta layer and cyan layer of the TA paper is likewise carried out based on M data and C data and the color image is printed on the TA paper in this way. The printer 166 in this embodiment is a TA printer, but the present invention is not limited to this and the present invention is also applicable to other types of printer such as a thermal printer and ink jet printer.

Furthermore, the printing device 150 is provided with a data editing section 182, a font library 184, a text/image conversion section 186, and a text image synthesis section 188.

The data editing section 182 is a functional section which edits text data embedded in image data and includes an editor for editing and laying out the text data based on input from the touch panel 172. The font library 184 stores various character fonts and allows a font of text data to be changed based on the input from the touch panel 172.

The text/image conversion section 186 converts text data to text image data. This text image data is text data converted into a file format similar to that of the image data to be embedded. The text image synthesis section 188 embeds this text image data in the image data.

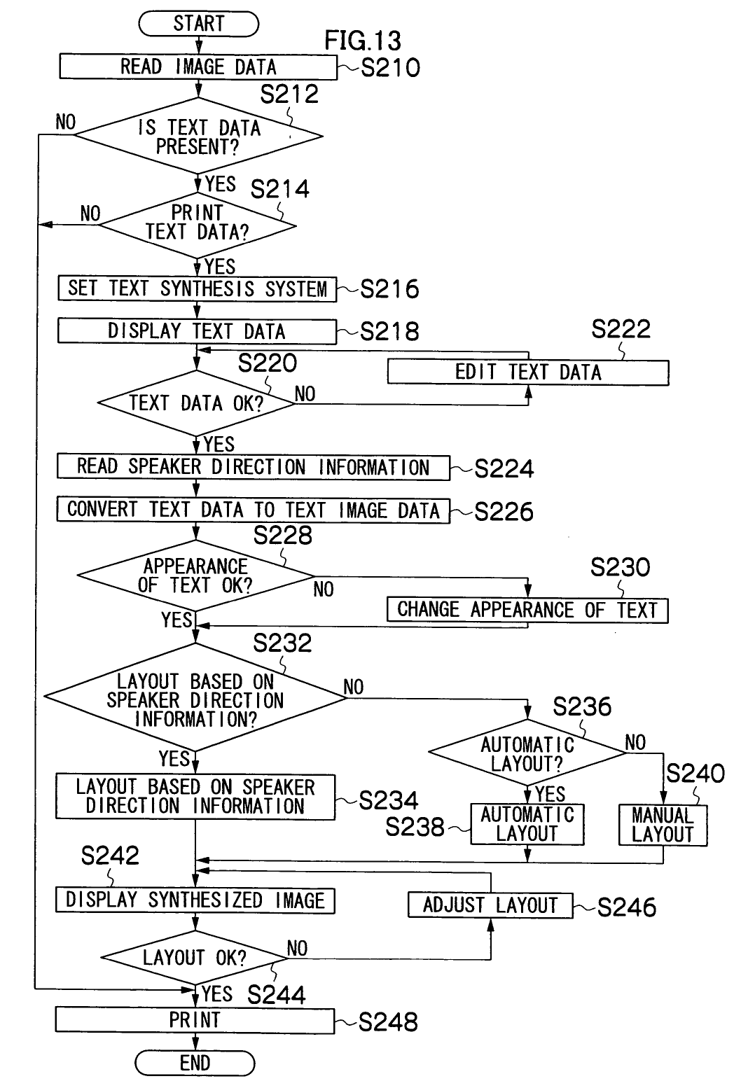

Next, printing operation by the printing device 150 having the above described structure will be explained with reference to a flow chart in FIG. 13. FIG. 13 is a flow chart showing the printing operation by the printing device 150.

First, when image data is read from the recording media 106 (step S210), it is decided whether text data is embedded in the image data read or not (step S212). When the text data is not embedded in step S212, the process moves to step S248, the number of prints, size or sheet is specified through the touch panel 172 and the image data is printed.

On the other hand, when the text data is embedded in step S212, a selection screen for selecting whether the text data is printed together with the image data or not is displayed on the display 174 (step S214). When the text data is not printed in step S214, the process moves to step S248 and the image data is printed. On the other hand, when the text data is printed in step S214, a synthesis system for the text data is set (step S216), the text data is laid out based on the synthesis system set and displayed on the display 174 (step S218). In step S216, it is possible to lay out text data in a speech balloon, frame or the like through operation input from the touch panel 172.

Next, a selection screen for selecting whether the text data displayed on the display 174 is edited or not is displayed (step S220). When editing of the text data is selected in step S220, the text data is edited by the touch panel 172 (step S222) and the process moves back to step S220. In step S220, when editing of the text data is finished, the direction in which the speaker is located (speaker direction information) is read from the image data (step S224).

Next, the text data is converted to text image data in the format appropriate for embedding in the above-described image data by the text/image conversion section 186 (step S226). In step S226, the font library 184 is referenced, the font of the text data, font size, color, background color or character decoration (e.g., underline, boldface, italic type, shading, fluorescent pen, box character, character rotation, shaded character, outline type) or the like are set for every speaker (voice print registrant) or every speaker's direction. Then, a selection screen for selecting whether the above described appearance such as a font of the text data is changed or not is displayed on the display 174 (step S228). When the appearance of the text data is not changed in step S228, the process moves to step S232. On the other hand, when the appearance of the text data is changed in step S228, the appearance of the text data is changed through operation input from the touch panel 172 (step S230) and the process moves to step S232.

Next, a layout method when text image data is laid out on the image data is selected (steps S232 and S236). When laying out the text image data based on the speaker's direction information is selected in step S232, the text image data is laid out in step S234. On the other hand, when an auto layout is selected instead of the speaker's direction information (step S236), the text image data is automatically laid out by the data editing section 182 (step S238). Furthermore, when a manual layout is selected (step S236), the text image data is manually laid out through operation input from the touch panel 172 (step S240).

Then, a synthesized image (step S242) in which the text image data are synthesized is displayed and a confirmation screen of the layout is displayed on the display 174 (step S244). When editing of the layout is selected in step S244, the layout is adjusted through operation input from the touch panel 172 (step S246), the process moves back to step S242. Next, when the layout of the text image data is completed (step S244), the number of prints, size, sheet or the like is specified by the touch panel 172 and the synthesized image is printed (step S248).

According to the image output device (printing device) 150 of the present embodiment, it is possible to synthesize and print a voice or the like with image data when an image is taken and thereby obtain impressive prints with high added values. Furthermore, even when the imaging device does not have a layout or synthesis function of text data and image data, it is possible to synthesize the image data and text data and print the synthesized data.

Note that the above described embodiments may also be adapted in such a way that the model name of the imaging device 10, specifications of the optical system 54 (e.g., focal length, zoom position), sensitivity of the image pickup element, shutter speed, date and time of image taking or the like are embedded in the image as text data.

What is claimed is:

1. An imaging device, comprising:
an image pickup device which takes an image of a speaker;
a voice input device which inputs a voice of the speaker;
a voice print registration device which registers a voice print of the speaker;
a voice extraction device which filters the voice input by the voice input device and extracts the voice corresponding to the voice print registered in the voice print registration device;
a text data generation device which converts the extracted voice to text data; and
a recording device which records the image taken by the image pickup device associated with the text data.

2. The imaging device according to claim 1, wherein the voice print registration device registers voice prints of a plurality of speakers associated with speaker identification information which identifies the speakers, and
when voices of the plurality of speakers are input, the text data generation device makes the text data distinguishable for each of the speakers.

3. The imaging device according to claim 1, further comprising an image/text synthesis device which synthesizes the image with text image data which is the text data converted to an image.

4. The imaging device according to claim 2, further comprising an image/text synthesis device which synthesizes the image with text image data which is the text data converted to an image.

5. The imaging device according to claim 4, wherein the image/text synthesis device changes at least one of a character font of the text image data, font size, color, background color, character decoration or column setting for each of the speakers.

6. The imaging device according to claim 5, further comprising an extracted voice specification device which selects the speaker identification information and specifies a speaker whose voice is to be extracted by the voice extraction device.

7. The imaging device according to claim 6, further comprising a speaker direction calculation device which calculates a direction in which the speaker who utters the voice is located based on the input voice,
wherein the image/text synthesis device lays out the text image data on the image based on the direction in which the speaker is located.

8. The imaging device according to claim 7, wherein the voice input device is made up of a plurality of microphones, and
the speaker direction calculation device calculates the direction in which the speaker is located based on differences in sound levels of voices input from the plurality of microphones.

9. The imaging device according to claim 1, further comprising a text editing device which edits the text data.

10. The imaging device according to claim 8, further comprising a text editing device which edits the text data.

11. An image output device, comprising:
a data input device which inputs an image and text data associated with the image;
an image/text synthesis device which changes, when the text data is converted to text in such a way that words uttered by a plurality of speakers are made distinguishable for each of the speakers, at least one of a character font of the text image data, font size, color, background color, character decoration or column setting for each of the speakers, synthesizes the text image data with the image to create a synthesized image; and
an output device which outputs the synthesized image.

12. The image output device according to claim 11, further comprising a text editing device which edits the text data.

13. The image output device according to claim 11, wherein the output device is a printer which prints the image.

14. The image output device according to claim 12, wherein the output device is a printer which prints the image.

15. An image output device, comprising:
a data input device which inputs an image and text data associated with the image;
an image/text synthesis device which lays out, when the text data includes information on a direction in which the speaker is located when an image is taken, the text image data on the image based on the direction in which the speaker is located to create a synthesized image; and
an output device which outputs the synthesized image.

16. The image output device according to claim 15, further comprising a text editing device which edits the text data.

17. The image output device according to claim 15, wherein the output device is a printer which prints the image.

18. The image output device according to claim 16, wherein the output device is a printer which prints the image.
